(19) United States
(12) Patent Application Publication
(10) Pub. No.: US 2023/0017058 A1
(43) Pub. Date: Jan. 19, 2023

(54) VEHICLE WHEELS AND METHODS OF USE

(71) Applicant: Howmet Aerospace Inc., Pittsburgh, PA (US)

(72) Inventors: Douglas P. Mason, Livonia, MI (US); Spencer Wallace, Broadview Heights, OH (US); Michael Sutadji, Highland Heights, OH (US)

(21) Appl. No.: 17/375,460

(22) Filed: Jul. 14, 2021

(51) Int. Cl. B60B 21/02; B60B 3/02; B60B 21/10; B60B 3/06

(52) U.S. Cl. CPC B60B 21/023; B60B 3/02; B60B 21/026; B60B 21/104; B60B 3/06; B60C 29/02

(57) ABSTRACT

Vehicle wheels and methods of use are provided. The vehicle wheel comprises a first region, a second region, and a third region. The first region is generally annular and comprises a first flange, a second flange opposite the first flange, and a continuous wall comprising an inner surface and an outer surface. A first tire bead seat and a second tire bead seat are defined on the outer surface. The second region is configured to mount to a vehicle axle and is offset from the first flange by an offset distance. The third region connects the second region and the third region and extends inwardly towards the longitudinal axis from an attachment location on the first region to the second region. The third region comprises a first thickness and the second region comprises a second thickness. The first thickness is no greater than 75% of the second thickness.

### FIELD OF USE

The present disclosure relates to vehicle wheels.

### BACKGROUND

The weight of a vehicle wheel of a powered vehicle can affect the fuel efficiency of the powered vehicle. There are challenges associated with reducing the weight of a vehicle wheel while maintaining desired performance of the vehicle wheel.

### SUMMARY

According to one aspect of the present disclosure, a vehicle wheel is provided. The vehicle wheel comprises a first region, a second region, and a third region. The first region is generally annular and comprises a first flange, a second flange opposite the first flange, a continuous wall comprising an inner surface and an outer surface. A first tire bead seal and a second tire bead seat are defined on the outer surface. The continuous wall is disposed about a longitudinal axis of the vehicle wheel and extends from the first flange to the second flange. The second region is configured to mount to a vehicle axle and is offset from the first flange by an offset distance. The third region connects the first region and the second region and comprises a first thickness. The third region extends inwardly towards the longitudinal axis from an attachment location on the first region to the second region. The second region comprises a second thickness, and the first thickness is no greater than 75% of the second thickness.

According to another aspect of the present disclosure, a vehicle wheel is provided. The vehicle wheel comprises a first region, a second region, and a third region. The first region is generally annular and comprises a first flange, a second flange opposite the first flange, and a continuous wall comprising an inner surface and an outer surface. A first tire bead seat and a second tire bead seat are defined on the outer surface. The first tire bead seat comprises a bead seat width. The continuous wall is disposed about a longitudinal axis of the vehicle wheel and extends from the first flange to the second flange. The second region is configured to mount to a vehicle axle and the second region is offset from the first flange by an offset distance. The third region connects the first region and the second region. The third region extends inwardly towards the longitudinal axis from an attachment location on the first region to the second region. The attachment location is at a first distance from a point at the intersection of a radius of the first flange and an angle defined by the first bead seat, and the first distance is at least 50% of the head seat width.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a front perspective view of a non-limiting embodiment of a vehicle wheel according to the present disclosure;

FIG. 2 is a rear perspective view of the vehicle wheel of FIG. 1;

FIG. 3 is a top view of the vehicle wheel of FIG. 1;

FIG. 4 is a bottom view of the vehicle wheel of FIG. 1;

FIG. 5 is a left side devotional view of the vehicle wheel of FIG. 1;

FIG. 6 is a right side elevational view of the vehicle wheel of FIG. 1;

FIG. 7 is a front elevational view of the vehicle wheel of FIG. 1;

FIG. 8 is a rear elevational view of the vehicle wheel of FIG. 1;

FIG. 9 is a cross-sectional view showing aspects of the vehicle wheel of FIG. 1, sectioned along line 9-9 in FIG. 7;

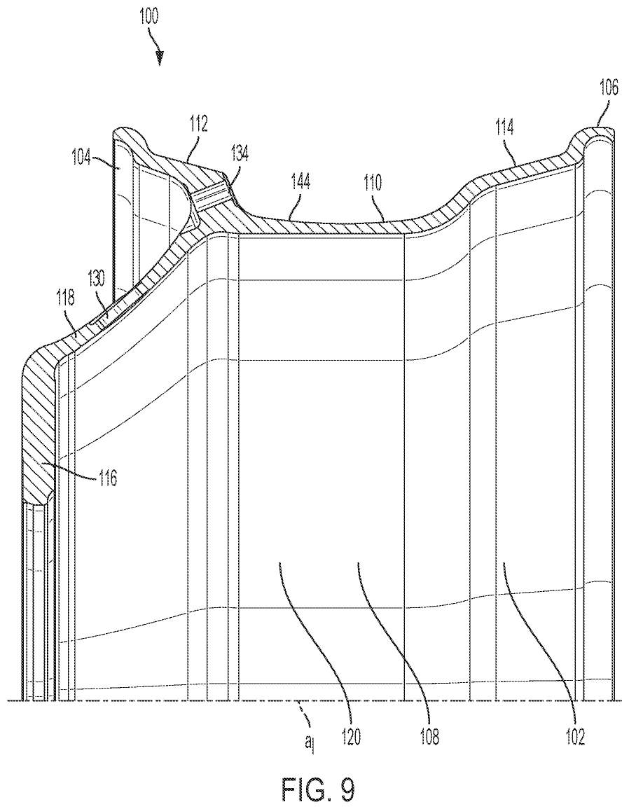

FIG. 10 is a profile view of FIG. 9;

FIG. 11 is a detail view of region 11 in FIG. 10;

FIG. 12 is a cross-sectional view of an assembly comprising a tire and a non-limiting embodiment of a vehicle wheel according to the present disclosure; and

FIG. 13 is a non-limiting embodiment of a dual vehicle wheel assembly according to the present disclosure with one of the vehicle wheels shown in phantom.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments”, “some embodiments”, “one embodiment”, “an embodiment”, “a non-limiting embodiment”, or like phrases mean that a particular feature, structure, or characteristic described in connection with the example is included in at least one embodiment. Thus, appearances of the phrases “in various non-limiting embodiments”, “in some embodiments”, “in one embodiment”, “in an embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

The present inventors observed that various conventional vehicle wheels, such as, for example, conventional vehicle wheels comprising aluminum or an aluminum alloy, utilize a cantilever loading-bearing arrangement between the tire loading surface and the central disc face of the vehicle wheel. The conventional vehicle wheels typically comprise a thick disc face to resist bending moments caused by the cantilever loading. For this reason, reducing wall thickness in the disc face has been undesirable.

The present disclosure is directed to a vehicle wheel utilizing a modified loading arrangement. An advantage of the modified loading arrangement is that thickness in the disc face of the vehicle wheel can be reduced without compromising wheel performance. The present disclosure provides a vehicle comprising a first region, a second region, and a third region. The first region is generally annular and comprises a first flange, a second flange opposite the first flange, and a continuous wall comprising an inner surface and an outer surface. A first tire bead seat and a second tire bead seat are defined on the outer surface. The first tire bead seat comprises a bead seat width. The continuous wall is disposed about a longitudinal axis of the vehicle wheel and extends from the first flange to the second flange. The second region is configured to mount to a vehicle axle and is offset from the first flange by an offset distance. The third region connects the first region and the second region and comprises a first thickness. The third region extends inwardly towards the longitudinal axis from an attachment location on the first region to the second region. In certain non-limiting embodiments of a vehicle wheel according to the present disclosure, the second region comprises a second thickness, and the first thickness is no greater than 75% of the second thickness. In certain non-limiting embodiments of a vehicle wheel according to the present disclosure, the attachment location on the first region is at a first distance from a point at the intersection of a radius of the first flange and an angle defined by the first bead seat, and the first distance is at least 50% of the bead seat width.

The present inventors observed that embodiments of a vehicle wheel having the design of the present disclosure may include less mass/weight than various conventional vehicle wheels, while maintaining desired performance characteristics. For example, positioning the attachment point at the first distance and reducing bending moments in the third region enables a reduction in wall thickness of the second region while maintaining a desired load capacity.

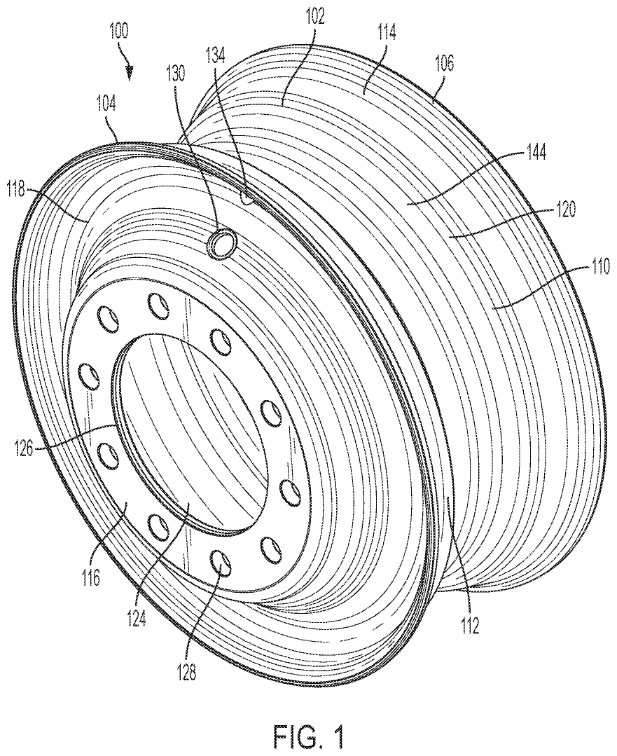

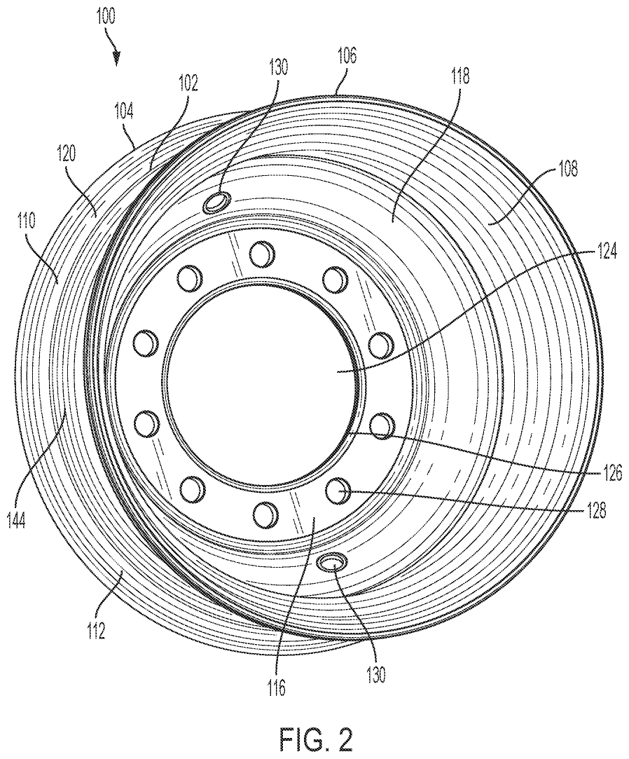

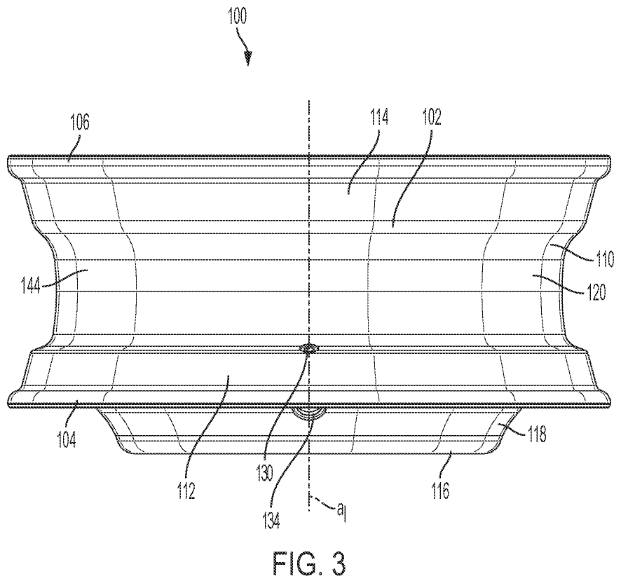

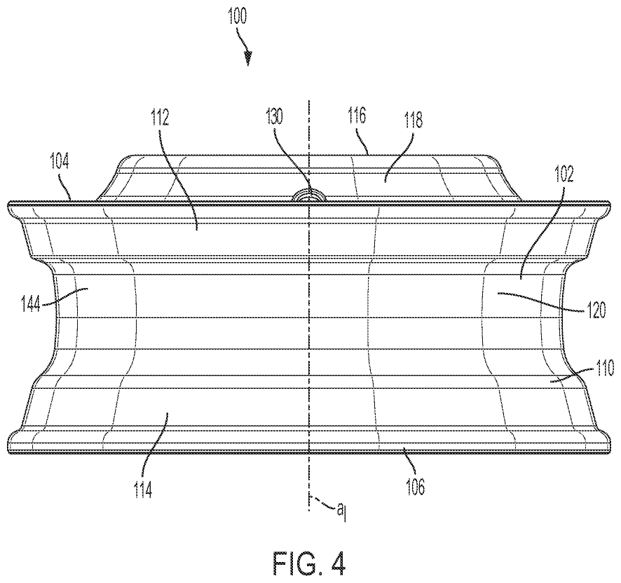

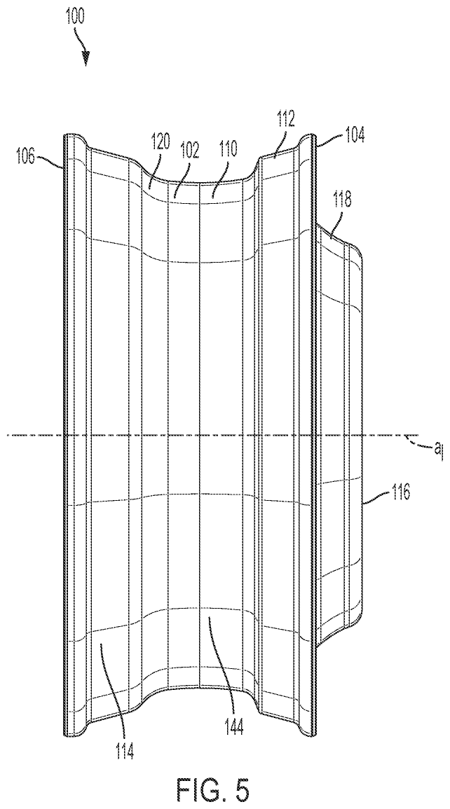

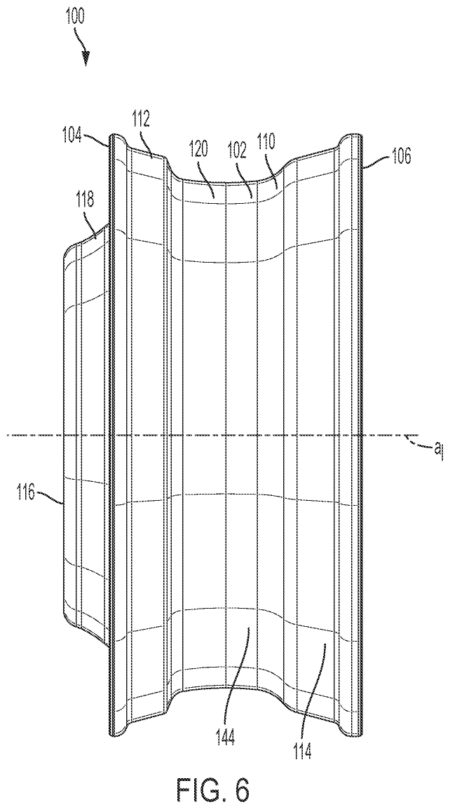

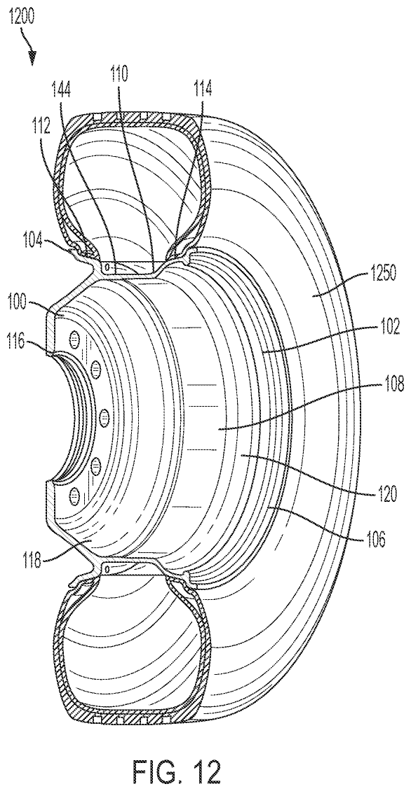

FIGS. 1-8 illustrate various views of a non-limiting embodiment of a vehicle wheel 100 according to the present disclosure. The vehicle wheel 100 comprises a first region 102, a second region 116, and a third region 118. The first region 102 can be generally annular and can comprise a first flange 104, a second flange 106, and a continuous wall 120 disposed about a longitudinal axis, aₗ, of the vehicle wheel 100. The continuous wall 120 can extend from the first flange 104 to the second flange 106. The continuous wall 120 comprises an outer surface 110 (e.g., tire side surface) and an inner surface 108. The outer surface 110 can define a first tire bead seat 112 and a second tire bead seat 114, which both can be disposed about a circumference of the outer surface 110 of the first region 102. The first tire bead seat 112 and the second tire bead seat 114 can be configured such that a tire (e.g., tire 1250 in assembly 1200 of FIG. 12) can be mounted thereon and form a generally airtight seal therewith. The tire 1250 can comprise any suitable dimensions for mounting on the first tire bead seat 112 and the second tire bead seat 114 of the outer surface 110. For example, depending on the dimensions of the first tire bead seat 112 and the second tire bead seat 114, the tire 1250 can comprise dimensions of 11R22.5, 295/75R22.5, 11R24.5, 285/75R24.5, or other suitable dimensions.

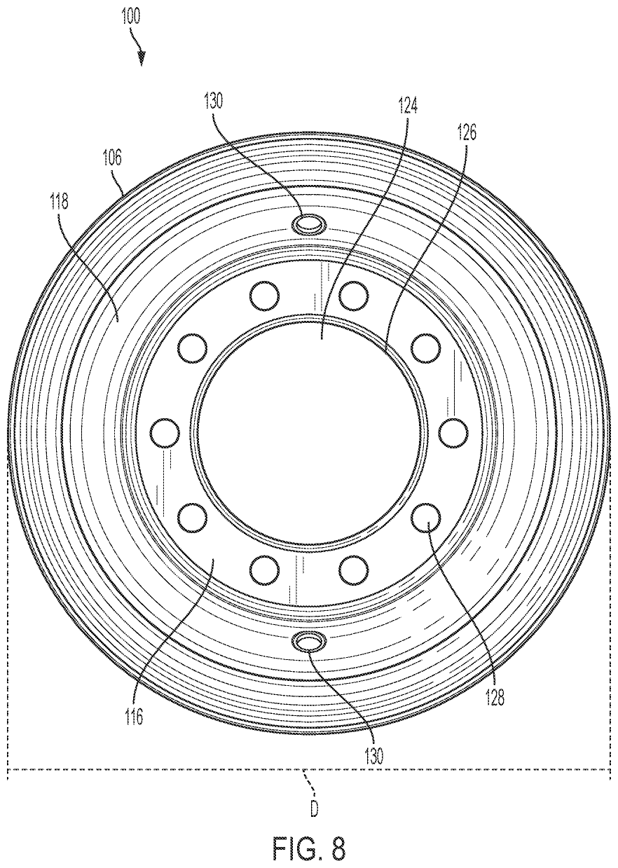

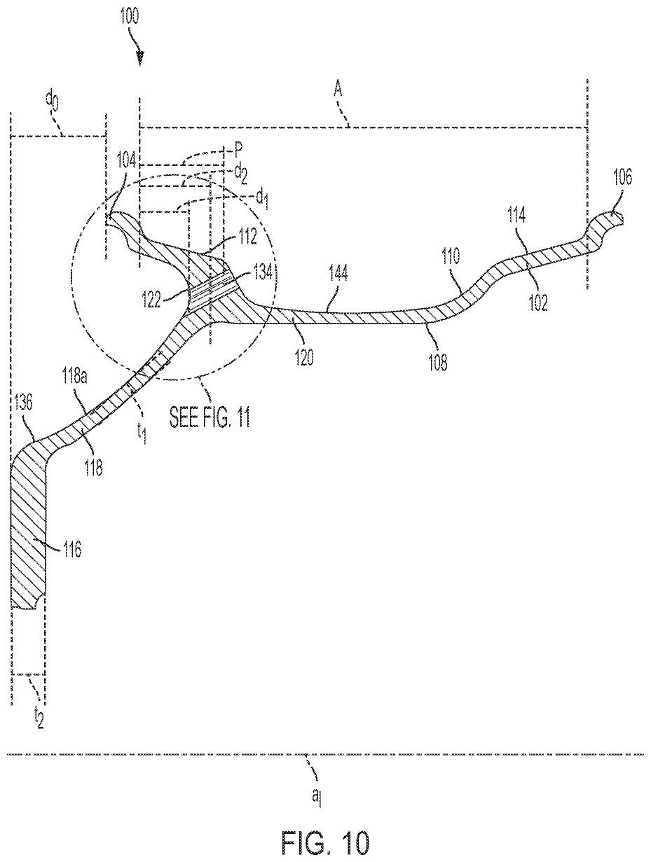

Referring to FIGS. 8 and 10, the first region 102 can comprise a nominal rim width, A, and a nominal rim diameter, D, adapted to receive a tire. In various non-limiting embodiments, referring to FIG. 10, the first region 102 can comprise a nominal rim width, A, in a range of 1 inch (2.54 mm) to 100 inches (2540 mm), such as, for example, 6 inches (152.4 mm) to 24 inches (609.6 mm), 6 inches (152.4 mm) to 12 inches (304.8 mm), or 5.5 inches (139.7 mm) to 17 inches (431.8 mm), For example, and without limitation, in certain non-limiting embodiments, the nominal rim width, A, of the first region 102 can be 8.25 inches (209.6 mm) or 11 inches (279.4 mm).

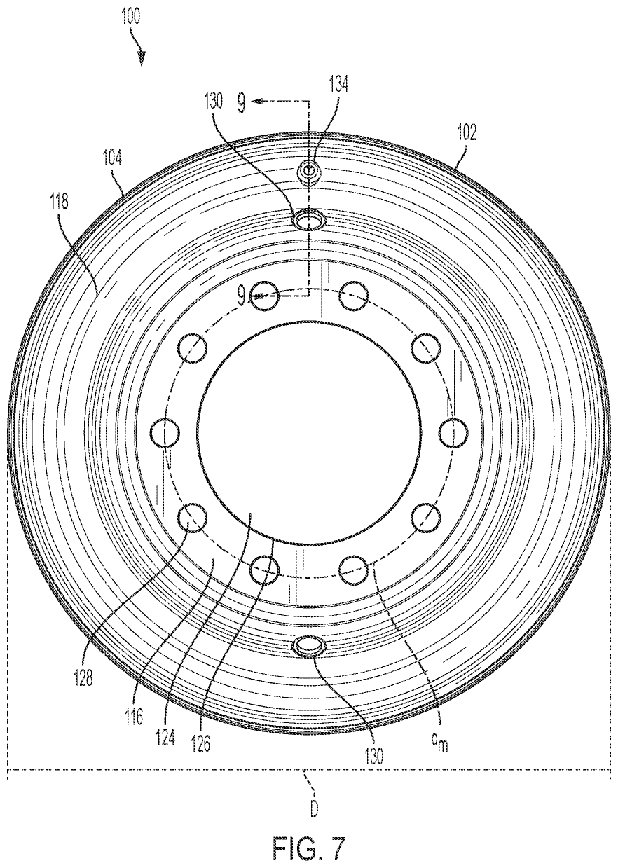

In various non-limiting embodiments, referring to FIGS. 7 and 8, the first region 102 can comprise a nominal rim diameter, D, in a range of 1 inch (2.54 mm) to 200 inches (5080 mm), such as, for example, 14 inches (406.4 mm) to 25 inches (635 mm), 19 inches (482.6 mm) to 25 inches (635 mm), or 16 inches (406.4 mm) to 24 inches (609.6 mm). For example, and without limitation, in certain non-limiting embodiments, the nominal rim diameter, D, of the first region 102 can be 22.5 inches (571.5 mm) or 24.5 inches (622.3 mm).

Referring again to FIGS. 1-2 and 7-8, the second region 116 of the vehicle wheel 100 is configured to mount to a vehicle axle (not shown). For example, the second region 116 can comprise a hub surface 126 defining an opening 124 that can be configured to receive at least a portion of a hub of the vehicle axle. The hub surface 126 can be configured to engage the hub of the vehicle axle and facilitate alignment of the vehicle wheel 100 with the hub of the vehicle axle. In various non-limiting embodiments, the hub surface 126 can comprise a pilot bore suitable to engage a pilot tab of the hub of the vehicle axle. In various non-limiting embodiments, the second region 116 is substantially disc shaped and extends in a direction that is substantially perpendicular to the inner surface 108 of the first region 102 and the longitudinal axis, aₗ.

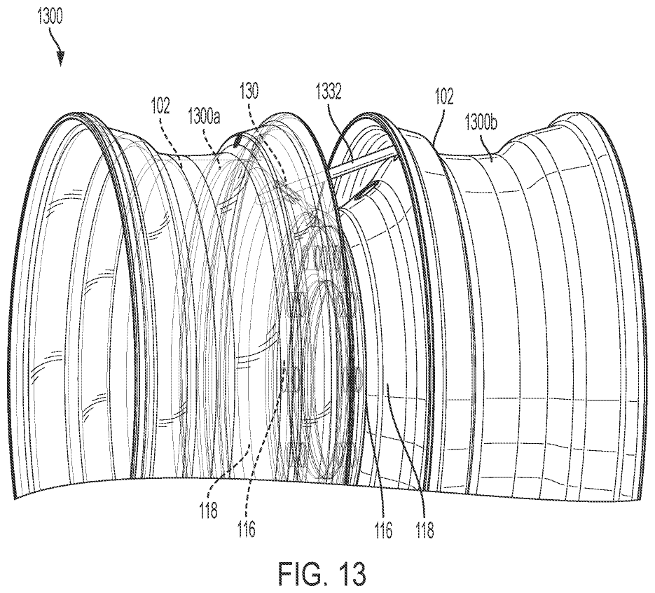

The second region 116 can be offset from the first flange 104 by an offset distance, dₒ. The offset distance, dₒ, is configured such that the vehicle wheel 100 can be mounted in a dual wheel configuration. For example, as illustrated in FIG. 13, the first vehicle wheel 1300a and the second vehicle wheel 1300b are mounted in a dual wheel configuration with the second region 116 of the first vehicle wheel 1300a contacting the second region 116 of the second vehicle wheel 1300b. The offset distance, dₒ, can be in a direction away from the second flange 106. The offset distance, dₒ, can be, for example, at least 0.394 inches (10 millimeters), at least 0.59 inches (15 millimeters), at least 0.787 inches (20 millimeters), at least 0.984 inches (25 millimeters), at least 1.181 inches (30 millimeters), at least 1.378 inches (35 millimeters), at least 1.575 inches (40 millimeters), or at least 1,969 inches (50 millimeters).

In various non-limiting embodiments, the second region 116 can comprise at least two bores 128 extending through the second region 116. Each of the at least two bores 128 can be configured to receive a stud on a hub of a vehicle axle. Center points of each of bores 128 can be disposed evenly about a mounting circle, CUT. In various non-limiting embodiments, the mounting circle, cm, has a center point common with a center point of the second region 116. In various non-limiting embodiments, the mounting circle, cm, can comprise a mounting diameter in a range of 1 inch (25.4 mm) to 15 inches (381 mm). For example, the mounting diameter can be 11.25 inches (285.75 mm). In various non-limiting embodiments, each bore 128 can have a diameter in a range of 0.1 inches (2.54 mm) to 2 inches (50.8 mm). For example, each bore 128 can have a diameter of 1.023 inches (26 mm). In various non-limiting embodiments, the second region 116 can comprise ten bores 128, as illustrated in FIGS. 1-2 and 7-8, or eight bores (not shown).

The third region 118 connects the first region 102 and the second region 116. The third region 118 can extend inwardly towards the longitudinal axis, aₗ, from an attachment location 122 on the first region 102 to the second region 116. The second region 116 and the third region 118 can define a convex shape, such as, for example, a generally conical shape (e.g., a frustoconical shape or a frustum). Referring to FIG. 10, an outer surface 118a of the third region 118 can define a curve from the second region 116 to the first region 102, and the curve can be concave. In various non-limiting embodiments, the second region 116 transitions into the third region 118 at an inflection point 136.

In certain non-limiting embodiments, the third region 118 is integral with the first region 102 and the second region 116. For example, the vehicle wheel 100 can be a single piece wheel without any welds.

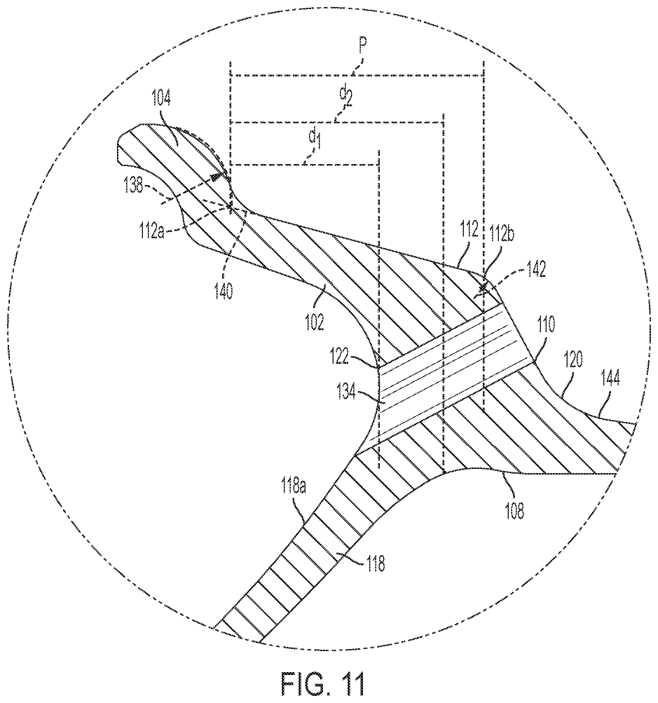

Referring to FIG. 11, the first tire bead seat 112 can comprise a bead seat width. P. For convenience, the bead seat width, P, will be described with respect to only the first tire bead seat 112, but will be understood that the second tire bead seat 114 can comprise substantially the same, if not an identical, bead seat width, P.

The bead seat width, P, is a dimension that accommodates the bead of a tire and is defined according to the 2021 Year Book published by the Tire and Rim Association, Inc., Akron, Ohio. For example, the bead seat width, P, can be a dimension between two points, 112a and 112b measured along the longitudinal axis, aₗ. Point 112a is defined by the intersection of a radius 138 of the first flange 104 and a bead seat angle 140 of the first tire bead seal 112. Point 112b is defined by the intersection of the bead seat angle 140 and a top well radius 142 of a dropwell 144 of the first region 102.

Referring to FIG. 11, the attachment location 122 can be defined by the intersection of a portion of the inner surface 108 of the first region 102 that is intermediate the first flange 104 and the third region 118 and an outer surface 118a of the third region 118. The attachment location 122 is furthest from the first flange 104 along the longitudinal axis, aₗ while still being intermediate the first flange 104 and the third region 118. The attachment location 122 is a first distance, di, from the point 112a along the longitudinal axis, aₗ. For example, the first distance, di, can be at least 50% of the bead seat width, P, such as, for example, at least 55%, at least 60%, at least 70%, or at least 75% of the bead seat width, P. The first distance, di, can be no greater than 200% of the bead seat width, P, such as, for example, no greater than 175%, no greater than 150%, no greater than 125%, or no greater than 100% of the head seat width, P. In certain non-limiting embodiments, the first distance, di, is in a range of 50% to 200% of the bead seat width, P, such as, for example, 50% to 150%, 50% to 100%, or 60% to 100% of the head seat width, P.

Referring to FIG. 11, the third region 118 comprises a first thickness, t₁. The first thickness, t₁, can be a minimum thickness of the third region 118. The second region 116 comprises a second thickness, t₂. The second thickness, t₂, can be a maximum thickness of the second region 116. The first thickness, t₁, can be no greater than 75% of the second thickness, t₂, such as, for example, no greater than 70%, no greater than 60%, no greater than 50%, no greater than 45%, no greater than 40%, or no greater than 35% of the second thickness, t₂. The first thickness, t₁, can be at least 10% of the second thickness, t₂, such as, for example, at least 15%, at least 20%, at least 25%, at least 30%, or at least 35% of the second thickness, t₂. In various non-limiting embodiments, the first thickness, t₁, can be in a range of 10% to 75% of the second thickness, such as, for example, 10% to 60%, 20% to 50%, or 25% to 45% of the second thickness, t₂. In certain non-limiting embodiments, the second thickness, t₂, can be at least 0.630 inches (16 millimeters). In certain non-limiting embodiments, the first thickness, t₁, can be no greater than 0.59 inches (15 millimeters) or no greater than 0.394 inches (10 millimeters).

In various non-limiting embodiments, the first region 102 can comprise a valve stem mount bore 134. The valve stein mount bore 134 can be configured to receive a valve stem in order to control gas transport into and out of a tire mounted on the vehicle wheel 100. The valve stem mount bore 134 can be located within the first region 102 adjacent to the attachment location 122 such that the load capacity of the vehicle wheel 100 can be minimally, if at all, affected.

In various non-limiting embodiments, the third region 118 can comprise a peripheral opening 130. As shown in FIGS. 1-2 and 7-8, the vehicle wheel 100 can comprise two peripheral openings 130 or, in other non-limiting embodiments, the vehicle wheel 100 can comprise greater than two peripheral openings (not shown). The peripheral openings 130 can provide access to a tire stem when the vehicle wheel 100 is configured in a dual wheel configuration. For example, referring to the dual vehicle wheel assembly 1300 shown in FIG. 13, the peripheral opening 130 of a first vehicle wheel 1300a can be aligned with a tire stem 1332 of a second vehicle wheel 1300b to enable access to the tire stem of 1332 while the dual vehicle wheel assembly 1300 is installed on a vehicle axle. In various non-limiting embodiments, the peripheral openings 130 can be less than 20 mm in diameter, such as, for example, less than 15 mm in diameter or less than 12 mm in diameter. Minimizing the number or and/or size of the peripheral openings can maintain a desired load capacity of the vehicle wheel 100.

In various non-limiting embodiments, the vehicle wheel according to the present disclosure can comprise a metal, a metal alloy, a composite material, or a combination thereof. For example, the vehicle wheel according to the present disclosure can comprise at least one of aluminum, an aluminum alloy, titanium, a titanium alloy, magnesium, a magnesium alloy, iron, an iron alloy, and carbon fiber. In certain non-limiting embodiments, the vehicle wheel according to the present disclosure comprises aluminum or an aluminum alloy.

In various embodiments, a vehicle wheel according to the present disclosure can be, for example, at least one of a bonded wheel, a welded wheel, a formed wheel (e.g., vacuum formed), a cured wheel, a cast wheel, a forged wheel, a machined wheel, and an additively manufactured wheel. In certain non-limiting embodiments, a vehicle wheel according to the present disclosure can be a cast wheel or a forged wheel that has been machined subsequent to casting or forging. For example, a vehicle wheel according to the present disclosure can comprise aluminum or an aluminum alloy and can be a cast wheel and/or a forged wheel.

In various non-limiting embodiments, a vehicle wheel according to the present disclosure can weigh at least 10 pounds (lbs.) (4.5 kg), such as, for example, at least 25 lbs. (11.3 kg), at least 30 lbs. (13.6 kg), at least 35 lbs. (15.9 kg), or at least 40 lbs. (18.1 kg). In some embodiments, a vehicle wheel according to the present disclosure can weigh no greater than 50 lbs. (22.7 kg), such as, for example, no greater than 40 lbs. (18.1 kg), no greater than 38 lbs. (17.2 kg), no greater than 37 lbs. (16.8 kg), no greater than 36 lbs. (16.3 kg, no greater than 35 lbs. (15.9 kg), no greater than 25 lbs, (11.3 kg), or no greater than 10 lbs. (4.5 kg). In certain non-limiting embodiments, a vehicle wheel according to the present disclosure can have a weight in a range of 10 lbs. (4.5 kg) to 50 lbs. (22.7 kg), such as, for example, 25 lbs. (11.3 kg) to 40 lbs. (18.1 kg), or 30 lbs. (13.6 kg) to 38 lbs. (17.2 kg).

In various non-limiting embodiments, the load rating of a vehicle wheel according to the present disclosure can be at least 1,000 pounds (lbs.) (453.6 kg), such as, for example, at least 5,000 lbs. (2268 kg), at least 9,000 lbs. (4082.3 kg), at least 10,000 lbs. (4535.92 kg), at least 13,000 lbs. (5896.7 kg), or at least 15,000 lbs. (6803.89 kg). In various non-limiting embodiments, the load rating of a vehicle wheel according to the present disclosure can be no greater than 20,000 lbs. (9071.85 kg), such as, for example, no greater than 15,000 lbs. (6803.89 kg), no greater than 13,000 lbs. (5896.7 kg), no greater than 10,000 lbs. (4535.92 kg), no greater than 9,000 lbs. (4082.3 kg), or no greater than 5,000 lbs. (2268 kg). In various non-limiting embodiments, the load rating of a vehicle wheel according to the present disclosure can be 1,000 lbs. (453.6 kg) to 20,000 lbs. (9071.85 kg), such as, for example, 5,000 lbs. (2268 kg) to 15,000 lbs. (6803.89 kg), or 9,000 lbs. (4082.3 kg) to 13,000 lbs. (5896.7 kg). In various embodiments, the load rating of a vehicle wheel according to the present disclosure can be at least 15,000 lbs. (6803.89 kg) and the vehicle wheel can weigh less than 38 lbs. (17.2 kg). In various non-limiting embodiments, the load rating to mass ratio of a vehicle wheel according to the present disclosure can be at least 200, such as, for example, at least 205.

In some non-limiting embodiments, a vehicle wheel according to the present disclosure can comprise: (i) a weight in a range of 30 lbs. (13.6 kg) to 38 lbs. (17.2 kg), such as, for example, 30 lbs. (13.6 kg) to 37 lbs. (16.8 kg); (ii) a nominal rim diameter, D, of the first region 102 of 22.5 inches (571.5 mm) or 24.5 inches (622.3 mm); (iii) a nominal rim width, A, of the first region 102 of 8.25 inches (209.6 mm) or 11 inches (279.4 mm); (iv) eight or ten bores 12; (v) peripheral openings 130 having a diameter of no greater than 20 mm; and (vi) a load rating to mass ratio of at least 200.

An aspect of the present disclosure is directed to a method for using a vehicle wheel according to the present disclosure. The method comprises mounting a vehicle wheel according to the present disclosure on a steer axle of a vehicle, a drive axle of a vehicle, or a trailer axle of a trailer. The vehicle can comprise a vehicle weight class in a range of 1 to 8, such as, for example, 3 to 8, as defined by the U.S. Federal Highway Administration. For example, in various non-limiting embodiments, the gross weight of the vehicle can be at least 10,001 lbs. (4536.48 kg) or at least 26,000 lbs. (11,798.4 kg). The vehicle can be, for example, a light-duty, medium-duty, or heavy-duty vehicle. In various non-limiting embodiments, the vehicle can be a truck (e.g., pick-up, full-sized, tractor (e.g., semi-truck)), a van, or a bus. The vehicle can comprise at least two axles, such as, for example, at least three axles, at least four axles, at least five axles, or at least six axles. In various non-limiting embodiments, the vehicle can comprise no greater than ten axles, such as, for example, no greater than six axles, no greater than five axles, no greater than four axles, or no greater than three axles. In various non-limiting embodiments, the vehicle can comprise a number of axles in a range of two to ten. The trailer can comprise a single axle or at least two axles, such as, for example, at least three axles, at least four axles, at least five axles, or at least six axles. In various non-limiting embodiments, the trailer can comprise no greater than ten axles, such as, for example, no greater than six axles, no greater than five axles, no greater than four axles, or no greater than three axles. In various non-limiting embodiments, the trailer can comprise one to ten axles.

An additional aspect according to the present disclosure is a vehicle comprising a vehicle wheel according to the present disclosure, or a trailer comprising a vehicle wheel according to the present disclosure. A further aspect according to the present disclosure a dual wheel configuration comprising two vehicle wheels according to the present disclosure.

Various aspects of the invention include, but are not limited to, the aspects listed in the following numbered clauses.

Clause 1. A vehicle wheel comprising:
a generally annular first region comprising
   a first flange,
   a second flange opposite the first flange,
   a continuous wall disposed about a longitudinal axis of the vehicle wheel and extending from the first flange to the second flange; the continuous wall comprising an inner surface and an outer surface, and
   a first tire bead seat and a second tire bead seat defined on the outer surface, wherein the first tire bead seat optionally comprises a bead seat width;
a second region configured to mount to a vehicle axle, wherein the second region is offset from the first flange by an offset distance; and
a third region connecting the first region and the second region, the third region extending inwardly towards the longitudinal axis from an attachment location on the first region to the second region,
wherein the third region comprises a first thickness, the second region comprises a second thickness, and the first thickness is no greater than 75% of the second thickness.
   Clause 2. A vehicle wheel comprising:
a generally annular first region comprising
   a first flange,
   a second flange opposite the first flange,
   a continuous wall disposed about a longitudinal axis of the vehicle wheel and extending from the first flange to the second flange, the continuous wall comprising an inner surface and an outer surface, and
   a first tire bead seat and a second tire bead seat defined on the outer surface, the first tire bead seat comprising a bead seat width;
a second region configured to mount to a vehicle axle, wherein the second region is offset from the first flange by an offset distance; and
a third region connecting the first region and the second region, the third region extending inwardly towards the longitudinal axis from an attachment location on the first region to the second region,
wherein the attachment location is at a first distance from a point at an intersection of a radius of the first flange and an angle defined by the first bead seat, and wherein the first distance is at least 50% of the bead seat width.
   Clause 3. The vehicle wheel of clause 2, wherein the third region comprises a first thickness, the second region comprises a second thickness, and the first thickness is no greater than 75% of the second thickness.
   Clause 4. The vehicle wheel of clause 1, wherein the attachment location is at a first distance from a point at an intersection of a radius of the first flange and an angle defined by the first bead seat, and wherein the first distance is at least 50% of the bead seat width.
   Clause 5. The vehicle wheel of any of clauses 2-4, wherein the first distance is no greater than 200% of the head seat width.
   Clause 6. The vehicle wheel of any of clauses 2-5, wherein the first distance is in a range of at least 50% of the bead seat width to no greater than 100% of the bead seat width.
   Clause 7. The vehicle wheel of any of clauses 1 and 3-6, wherein the first thickness is no greater than 50% of the second thickness.
   Clause 8. The vehicle wheel of any of clauses 1 and 3-7, wherein the first thickness is in a range of at least 20% of the second thickness to no greater than 50% of the second thickness.
   Clause 9. The vehicle wheel of any of clauses 1-8, wherein the second region and the third region define a frustoconical shape or a frustum.
   Clause 10. The vehicle wheel of any of clauses 1-9, wherein an outer surface of the third region defines a curve from the second region to the first region, wherein the curve is concave.
   Clause 11. The vehicle wheel of any of clauses 1-10, wherein the second region transitions into the third region at an inflection point.
   Clause 12. The vehicle wheel of any of clauses 1-11, wherein the vehicle wheel comprises a load rating to mass ratio of at least 200.
   Clause 13, The vehicle wheel of any of clauses 1-12, wherein the first region comprises a bore configured to receive a valve stem, wherein the bore is adjacent to the attachment location.
   Clause 14. The vehicle wheel of any of clauses 1-13, wherein the first region, the second region, and the third region are integral.
   Clause 15, The vehicle wheel of any of clauses 1-14, wherein the vehicle wheel comprises at least one of a metal, a metal alloy, and a composite.
   Clause 16. The vehicle wheel of any of clauses 1-15, wherein the vehicle wheel comprises at least one of aluminum and an aluminum alloy and is a cast vehicle wheel, a forged vehicle wheel, or a combination thereof.
   Clause 17, The vehicle wheel of any of clauses 1-16, wherein the first region comprises a nominal rim diameter in a range of 1 inch (2.54 mm) to 200 inches (5080 mm) and a nominal rim width in a range of 1 inch (2.54 mm) to 100 inches (2540 mm).
   Clause 18. The vehicle wheel of any of clauses 1-17, wherein the first region comprises a nominal rim diameter in a range of 16 inches (406.4 mm) to 24 inches (609.6 mm) and a nominal rim width in a range of 5.5 inches (139.7 mm) to 17 inches (431.8 mm).
   Clause 19, The vehicle wheel of any of clauses 1-18, wherein the first thickness is no greater than 0.394 inches (10 millimeters).
   Clause 20. The vehicle wheel of any of any of clauses 1-19, wherein the second thickness is at least 0.630 inches (16 millimeters).
   Clause 21. The vehicle wheel of any of clauses 1-20, wherein the offset distance is at least 0.394 inches (10 millimeters).
   Clause 22. Two of the vehicle wheels of any of clauses 1-21, wherein the two vehicle wheels are configured in a dual wheel configuration.

Clause 23. A vehicle comprising the vehicle wheel of any of clauses 1-21 or the two vehicle wheels of clause 22 in a dual wheel configuration.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A vehicle wheel comprising:
a generally annular first region comprising
a first flange,
a second flange opposite the first flange,
a continuous wall disposed about a longitudinal axis of the vehicle wheel and extending from the first flange to the second flange, the continuous wall comprising an inner surface and an outer surface, and
a first tire bead seat and a second tire bead seat defined on the outer surface;
a second region configured to mount to a vehicle axle, wherein the second region is offset from the first flange by an offset distance; and
a third region connecting the first region and the second region, the third region extending inwardly towards the longitudinal axis from an attachment location on the first region to the second region,
wherein the third region comprises a first thickness, the second region comprises a second thickness, and the first thickness is no greater than 75% of the second thickness.

2. The vehicle wheel of claim 1, wherein the first tire bead seat comprises a bead seat width and the attachment location is at a first distance from a point at an intersection of a radius of the first flange and an angle defined by the first tired bead seat, wherein the first distance is at least 50% of the bead seat width.

3. The vehicle wheel of claim 2, wherein the first distance is no greater than 200% of the bead seat width.

4. The vehicle wheel of claim 2, wherein the first distance is in a range of at least 50% of the bead seat width to no greater than 100% of the bead seat width.

5. The vehicle wheel of claim 1, wherein the first thickness is no greater than 50% of the second thickness.

6. The vehicle wheel of claim 1, wherein the first thickness is in a range of at least 20% of the second thickness to no greater than 50% of the second thickness.

7. The vehicle wheel of claim 1, wherein the second region and the third region define a frustoconical shape or a frustum.

8. The vehicle wheel of claim 1, wherein an outer surface of the third region defines a curve from the second region to the first region, wherein the curve is concave.

9. The vehicle wheel of claim 1, wherein the second region transitions into the third region at an inflection point.

10. The vehicle wheel of claim 1, wherein the vehicle wheel comprises a load rating to mass ratio of at least 200.

11. The vehicle wheel of claim 1, wherein the first region comprises a bore configured to receive a valve stem, wherein the bore is adjacent to the attachment location.

12. The vehicle wheel of claim 1, wherein the first region, the second region, and the third region are integral.

13. The vehicle wheel of claim 1, wherein the vehicle wheel comprises at least one of a metal, a metal alloy, and a composite material.

14. The vehicle wheel of claim 1, wherein the vehicle wheel comprises at least one of aluminum and an aluminum alloy, and wherein the vehicle wheel is one of a cast vehicle wheel, a forged vehicle wheel, or a combination thereof.

15. The vehicle wheel of claim 1, wherein the first region comprises a nominal rim diameter in a range of 1 inch (2.54 mm) to 200 inches (5080 mm) and a nominal rim width a range of 1 inch (2.54 mm) to 100 inches (2540 mm).

16. The vehicle wheel of claim 1, wherein the first region comprises a nominal rim diameter in a range of 16 inches (406.4 mm) to 24 inches (609.6 mm) and a nominal rim width in a range of 5.5 inches (139.7 mm) to 17 inches (431.8 mm).

17. The vehicle wheel of claim 16, wherein the first thickness is no greater than 0.394 inches (10 millimeters).

18. The vehicle wheel of claim 16, wherein the second thickness is at least 0.630 inches (16 millimeters).

19. The vehicle wheel of claim 1, wherein the offset distance is at least 0.394 inches (10 millimeters).

20. A vehicle wheel comprising:
a generally annular first region comprising
a first flange,
a second flange opposite the first flange,
a continuous wall disposed about a longitudinal axis of the vehicle wheel and extending from the first flange to the second flange, the continuous wall comprising an inner surface and an outer surface, and
a first tire bead seat and a second tire bead seat defined on the outer surface, the first tire bead seat comprising a bead seat width;
a second region configured to mount to a vehicle axle, wherein the second region is offset from the first flange by an offset distance; and
a third region connecting the first region and the second region, the third region extending inwardly towards the longitudinal axis from an attachment location on the first region to the second region,
wherein the attachment location is at a first distance from a point at an intersection of a radius of the first flange and an angle defined by the first tire bead seat, wherein the first distance is at least 50% of the bead seat width.
